(19) United States
(12) Patent Application Publication
(10) Pub. No.: US 2007/0164087 A1
(43) Pub. Date: Jul. 19, 2007

(54) Method for repair of housings

(75) Inventor: David A. Payne, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/333,710

(22) Filed: Jan. 17, 2006

(51) Int. Cl. B23K 31/02; B23K 31/00; B23K 1/20

(52) U.S. Cl. 228/119; 228/203

(57) ABSTRACT

A method is provided for repairing a housing having a bore formed therein, wherein the bore has an original diameter and a surface defined in part by the housing. The method may include the steps of preparing the housing bore by removing wear or damage near the bore surface, brazing a plug to the bore surface with a braze material, the plug having an outer diameter that is smaller than the bore original diameter, and machining the plug and a portion of the braze material out of the bore to the bore original diameter.

### TECHNICAL FIELD

The present invention relates to metal housings used for pumps, valves, actuators, or gearboxes, and more particularly, to a method for repairing such housings.

### BACKGROUND

Aircraft engines, including turbofan jet engines, turbojet engines, and turbine engines such as auxiliary power units, typically employ various housings for the disposal of pumps, valves, actuators, and gearboxes. These housings include bores and cavities formed therein within which shafts, gears, pistons, or other rotating or moving parts that couple to the pumps, valves, actuators, or gearboxes, are also disposed. In many cases, the engine may be configured such that a rotating or moving part contacts a surface of the housing.

During operation of the engine, the housing may become worn. For example, the contact between the rotating or moving parts and the housing may result in wear to the surfaces thereof. High pressure fluid flow through the housing bores, such as in a fuel or oil pump, may cause erosion of housing surfaces. Additionally, the housing may be exposed to extreme temperatures, which can impose stress on the aircraft engine and the housing, potentially causing wear thereon. In other examples, the housing may be exposed to functional vibration during operation which may also potentially cause housing wear.

Conventionally, housings that are subject to these types of wear are repaired using sleeves, plating, metal spray, or epoxy-based coatings that are applied to the worn section of the housing. Although these repair techniques are adequate in some circumstances, they may suffer from certain drawbacks. For example, sleeve repairs may not be useful for repairing certain housing geometries, plating and metal spray techniques may not yield desired results, and epoxy-based coatings, because of their relatively low melting temperatures, typically are not well-suited for repair of aircraft parts. As a result, when a housing is not repairable, it is generally discarded. However, because gearbox housings are relatively expensive to manufacture, or may not be commercially available, discarding and replacing the housing generally is not a desirable solution.

Thus, there is a need for a robust, low cost method for repairing an aircraft engine housing. Moreover, there is a need for a method of repair that allows a once-repaired housing that has been worn down again to be repaired again so that the component may be salvaged and not discarded. There is also a need to repair bores or areas of housings having limited access thereto, thin walls, or blind holes. Furthermore, other desirable features and characteristics of the present invention will become apparent from the subsequent detailed description of the invention and the appended claims, taken in conjunction with the accompanying drawings and this background of the invention.

### BRIEF SUMMARY

The present invention provides a method for repairing a housing having a bore formed therein, wherein the bore has an original diameter and a surface defined in part by the housing. The method includes the steps of brazing a plug to the bore surface with a braze material, the plug having an outer diameter that is smaller than the bore original diameter, and machining the plug and a portion of the braze material out of the bore to the bore original diameter.

In one embodiment, and by way of example only, the method includes removing a portion of the bore surface to thereby increase the bore original diameter to an oversize diameter. Next, a braze material is contacted to the bore surface. Then, a plug is inserted through the bore, the plug having an outer diameter that is smaller than the bore original diameter. The plug is brazed to the bore surface with the braze material. The plug is machined out of the bore until the diameter of the bore formed by the braze material is returned to the bore original diameter.

Other independent features and advantages of the preferred method will become apparent from the following detailed description, taken in conjunction with the accompanying drawings which illustrate, by way of example, the principles of the invention.

### BRIEF DESCRIPTION OF THE DRAWINGS

FIG. 1 is a cross-section side view of an exemplary gas turbine engine;

FIG. 2 is a cross section side view of the compressor section depicted in FIG. 1;

FIG. 3 is an exploded view of a gearbox housing of the exemplary compressor intermediate pressure section stages shown in FIG. 2;

FIG. 4 is a flowchart illustrating an exemplary method for repairing a housing having at least one bore;

FIG. 5 is a cross section view of an exemplary housing having braze material disposed thereon that may be used in the method depicted in FIG. 4; and

FIG. 6 is a cross section view of an exemplary housing having the braze material and an exemplary plug thereon.

### DETAILED DESCRIPTION OF A PREFERRED EMBODIMENT

Before proceeding with a detailed description, it is to be appreciated that the described embodiment is not limited to use in conjunction with a particular type of turbine engine, or even to use in a turbine engine. Thus, although the present embodiment is, for convenience of explanation, depicted and described as being implemented in an angle gearbox housing for a gas turbine jet engine, it will be appreciated that it can be implemented in various other types of housings having a bore formed therein within which a rotating or moving components may be disposed, and in various other systems and environments, such as, for example, multi-spool engines.

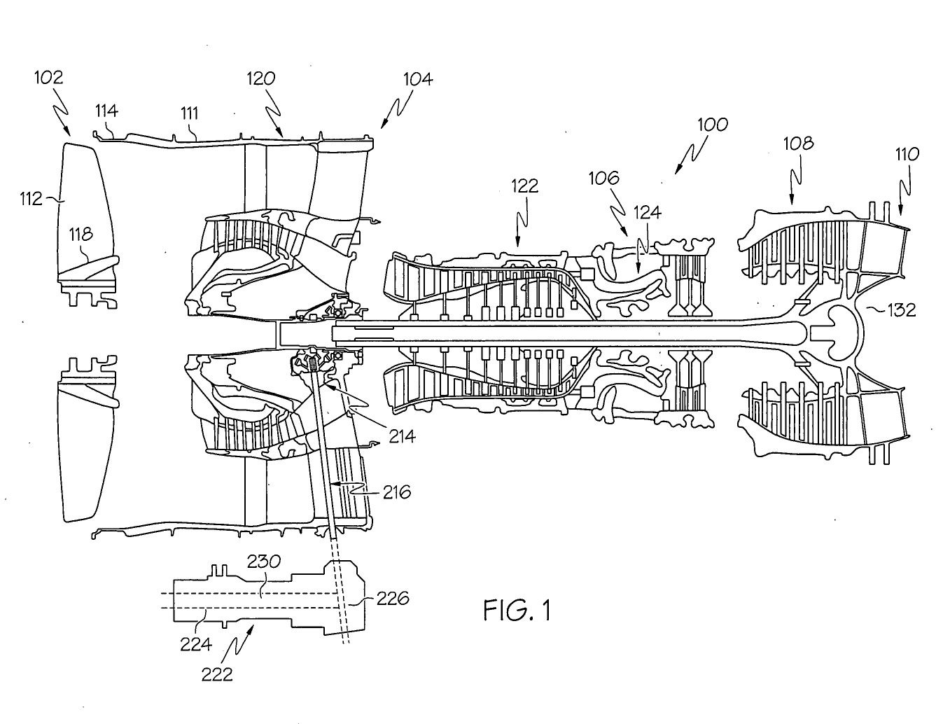

A portion of an exemplary embodiment of a gas turbine jet engine 100 is depicted in FIG. 1, and includes an intake module 102, a compressor module 104, a combustor module 106, a turbine module 108, and an exhaust module 110. Each of these modules 102-110 are contained within a housing 111, only a portion of which is shown. The intake module 102 includes a fan 112, which is mounted in a fan case 114. The fan 112 draws air into the intake module 102 and accelerates it. A fraction of the accelerated air exhausted from the fan 112 is directed through a bypass section (not indicate) disposed between the fan case 114 and an engine cowl 118, and provides a forward thrust. The remaining fraction of air exhausted from the fan 112 is directed into the compressor module 104.

In the depicted embodiment, the compressor module 104 includes two compressors, an intermediate pressure compressor 120, and a high pressure compressor 122. The intermediate pressure compressor 120 raises the pressure of the air directed into it from the fan 112, and directs the compressed air into the high pressure compressor 122. The high pressure compressor 122 compresses the air still further, and directs the high pressure air into the combustion section 106. In the combustion module 106, which includes a plurality of combustors 124, the high pressure air is mixed with fuel and combusted. The combusted air is then directed into the turbine module 108.

The turbine module 108 includes a plurality of turbines disposed in axial flow series. The combusted air from the combustion module 106 expands through each turbine, causing it to rotate. The air is then exhausted through a propulsion nozzle 132 disposed in the exhaust module 110, providing additional forward thrust. As the turbines rotate, each drives equipment in the engine 100 via concentrically disposed shafts or spools. For example, a high pressure turbine can drive the high pressure compressor 122 via a high pressure spool, an intermediate pressure turbine can drive the intermediate pressure compressor 120 via an intermediate pressure spool, and a low pressure turbine can drive the fan 112 via a low pressure spool.

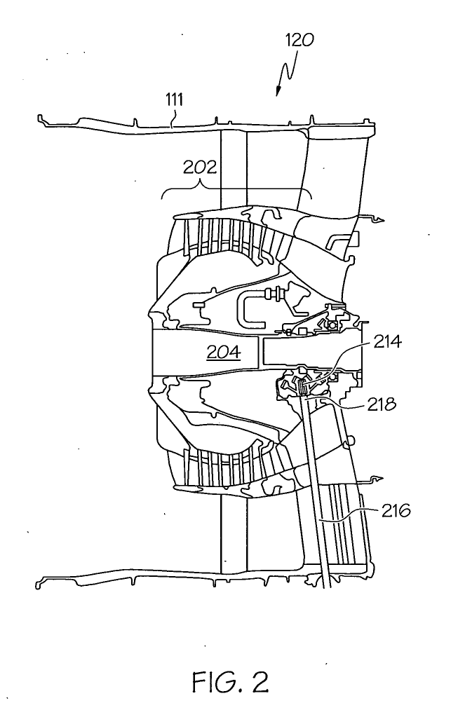

With additional reference to FIG. 2, a more detailed description of the intermediate pressure compressor 120 of the compressor module 104 in the above-described engine 100 will be provided. The intermediate pressure compressor 120 includes multiple stages 202 that each includes a rotor and a stator. The stages 202 are each rotationally mounted about a central axis 204. As the rotors rotate around the axis 204, air is forced through each of the stators, traveling at an angle into a subsequent stage thereby increasing the air pressure as the air travels from stage to stage.

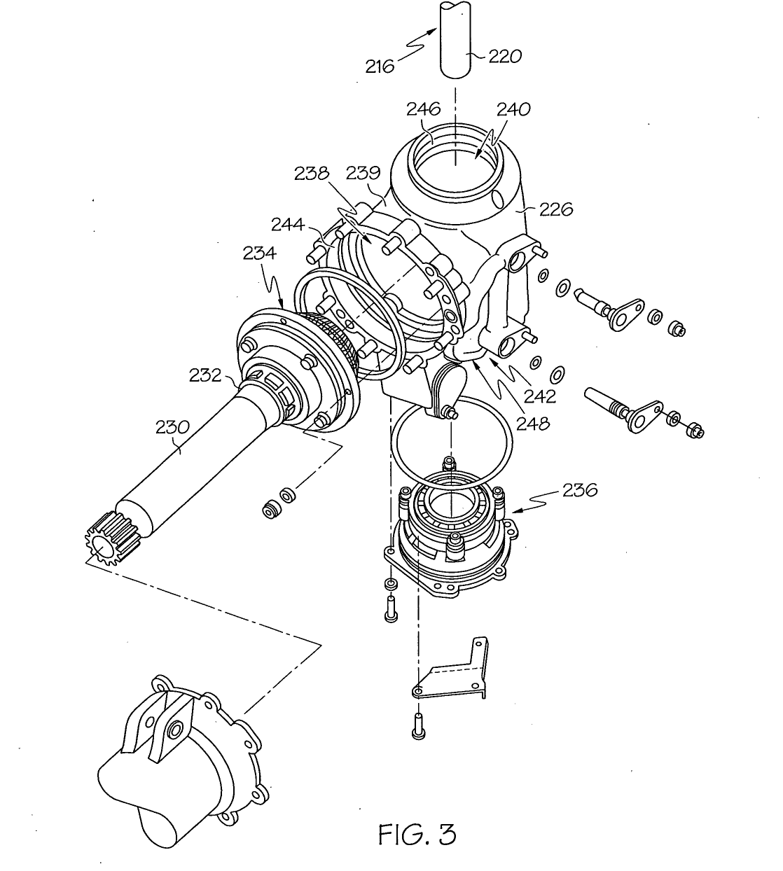

The stages 202 and other rotating components of the intermediate pressure compressor 120 power two shafts—a power takeoff (PTO) shaft 216 and a main shaft 230 (see FIG. 1). The PTO shaft 216 has first and second ends 218, 220. The first end 218 is rotationally mounted to a gear assembly 214 that is coupled proximate the central axis 204 and configured to transfer rotational power from the PTO shaft 216 to the components rotationally mounted about the axis 204. Thus, when the PTO shaft 216 rotates in a first direction, the gear assembly 214 translates the motion to a second direction, which is the direction in which the compressor components rotate, to cause rotation of those components. The second end 220 of the PTO shaft 216 is configured to couple to the main shaft 230 via a PTO shaft gear assembly 236 (see FIG. 3). The main shaft 230 resides outside of the housing 111.

The two shafts 216, 230, and associated gear and bearing assemblies are disposed in a gearbox housing 222. The gearbox housing 222 includes two sections, namely, a main gearbox housing 224 and an angle gearbox housing 226 (see FIGS. 1 and 3). The main gearbox 224 is configured to receive and contain the main shaft 230, while the angle gearbox 226 is configured to house a portion of the PTO shaft 216. The gearboxes 224, 226 are typically constructed to withstand thermal, mechanical, and/or environmental stresses and may be made of any one of numerous suitable aluminum alloys or magnesium alloys.

Turning now to FIG. 3, it is seen that the angle gearbox 226 includes three bores 238, 240, 242 (only two are clearly shown in FIG. 3) that are formed in a portion of the sidewall thereof and defined by suitably shaped inner surfaces 244, 246, 248. The main bore 238 is configured to receive and contain a main gear assembly 234 and a main shaft coupling end 232, and serves as an interface for the main gear assembly 234 and the PTO shaft gear assembly 236. The other bores 240, 242 are configured to receive the PTO shaft 216 such as to allow the shaft 216 to extend therebetween. The other bores 240, 242 are also configured to provide support for the PTO shaft gear assembly 236 and to provide a seal against leakage of lubricants that are contained within the angle gearbox 226.

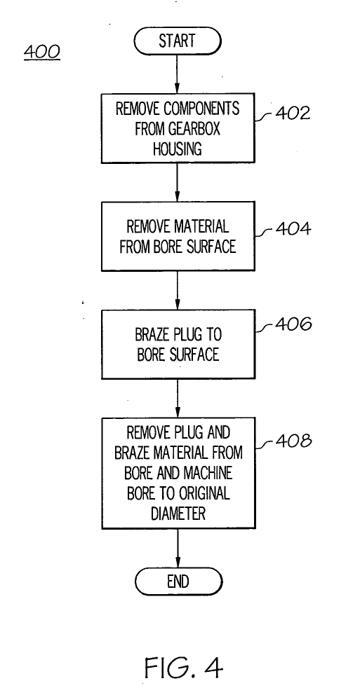

When the bore surfaces 244, 246, 248 are worn they may have scratches or the diameter of the bores 238, 240, 242 may be larger than, or discrepant from when originally manufactured. As a result, the angle gearbox housing 226 may require repair. One exemplary method 400 of repairing the bores 238, 240, 242 is depicted in FIG. 4. For ease of explanation, the exemplary method will be described as applied to the main bore 238. As will be appreciated, the method can be applied to the repair of the other angle gearbox bores 240, 242 as well, or any other type of bore that is formed in any other type of housing.

Before any process of the repair can begin, the shafts 216, 230, other components, and studs or fasteners contained within the angle gearbox housing 226 are removed, step 402. After the gearbox housing 226 is cleared, material is removed from the bore surface 244, step 404. Preferably, an amount of the housing 226 is removed that is sufficient to substantially eliminate the worn areas of the bore surface 244 and to form a bore 238 having a diameter that is larger than the original bore 238 diameter. It will be appreciated that the material may be removed in any manner. For example, the removal of material may be limited to the worn area. In another exemplary embodiment, a uniform amount of material is removed around the entire bore surface 244. The thickness and amount of material removed may vary widely.

It will further be appreciated that the bore 238 material may be removed from the bore surface 244 using any one of numerous conventional techniques. Suitable removal techniques include, for example, machining, grinding, drilling, sanding, cutting, or alternatively, electro-chemical machining. In some embodiments of the method 400, the bore surface 244 may need to be further prepared for application of the braze material. Thus, the bore surface 244 may additionally be grit-blasted, etched, polished, sanded, abraded, or another similar technique may be performed thereon to provide better adhesion or aid in bonding or wetting of the braze material.

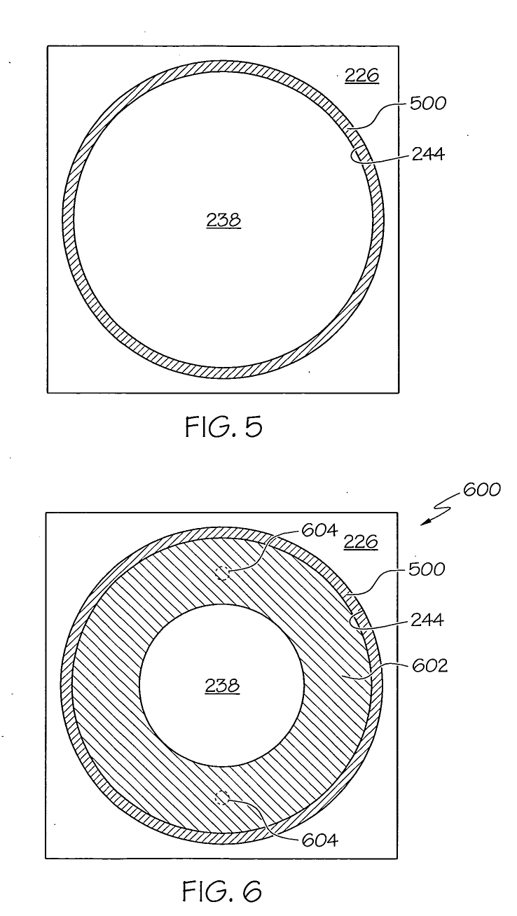

Turning to FIGS. 5 and 6, after the bore surface 244 is suitably prepared, a plug 602 is brazed thereto, step 406. In one exemplary embodiment, a braze material 500 is applied to the prepared bore surface 244, the plug 602 is inserted through the bore 238 to form an assembly 600, and the assembly 600 is subjected to heat to bond the plug 602 to the bore surface 244 via the braze material 500. The braze material 500 may be any one of numerous conventionally used braze materials; however, it will be appreciated that the selection of the particular braze material to be used depends largely on the material from which the housing 226 is constructed. For example, for aluminum housings, an aluminum-based braze material is preferred, while a magnesium-based braze material is preferably used for magnesium housings. It will further be appreciated that if the housing is made of cast iron or steel, other suitable braze materials may alternatively be used. Moreover, in some embodiments, the braze material 500 may be selected for properties that are improved over the original material of the housing 226. In one exemplary embodiment, the housing 226 is constructed of a metal alloy having a first formulation, while the braze material 500 may be a variation of the metal alloy having a second formulation that is more wear-resistant and/or corrosion-resistant than the first formulation. Additionally, the braze material 500 may be formulated as any one of a number of repair material configurations. For example, the braze material 500 may be configured as a paste, a sheet of foil, or a preform.

As mentioned above, the braze material 500 is then applied to the bore surface 244, as shown in FIG. 5. Preferably, a sufficient amount of braze material 500 is used to cover substantially all of the bore surface 244 forming a bore 238 diameter that is smaller than the original bore 238 diameter. The manner in which the braze material 500 is applied to the prepared bore surface 244 is largely dependent on the particular configuration of braze material 500 being used. In an embodiment in which the braze material 500 is a paste, the braze material may be painted or spread over the bore surface 244. In an embodiment in which sheets of foil are used, the sheets may be temporarily secured to the bore surface 244 mechanically. For example, the foil may be maintained in contact with the bore surface 244 via the plug 602, which will be described below. In still another embodiment, the braze material 500 may be a self-standing, hollow, tube-shaped preform having an outer diameter that is smaller than the diameter of the bore 238 and may be placed therein. Alternatively, the preform may be configured to be slip fit into the bore 238.

Briefly mentioned above, the plug 602 is inserted at least partially through the bore 238 to form an assembly 600, shown in FIG. 6, that is then subjected to heat. The plug 602 is preferably configured to be inserted at least partially through the bore 238 and to form an annular gap with the bore surface 244 within which the braze material 500 may be disposed, as shown in FIG. 6. In this regard, the plug 602 preferably has an outer diameter that is smaller than the original diameter of the bore 238. In some embodiments, the plug 602 may have an outer surface that is substantially complementary to the bore surface 244, or in cases in which the braze material configuration is a preform, may alternatively have an outer surface that is complementary to the shape of the preform. Additionally, the plug 602 itself may be hollow or solid.

In a preferred embodiment, the plug 602 is constructed from material that is substantially similar to the housing 226 material. In one exemplary embodiment, the plug 602 includes one or more heating elements 604, shown in phantom, that is embedded therein and configured to cause the plug 602 material to expand. The heating element 604 may be any one of numerous conventional devices, such as a resistive heating element or inductive coils, or, in other embodiments, may be heated by direct application of flame or hot air. In another exemplary embodiment, the plug 602 material is different than the housing 226 material. For example, the plug 602 material may be a different alloy of the housing 226 material. In still another exemplary embodiment, the plug 602 material is an alloy of the housing 226 material that is formulated to have a greater coefficient of thermal expansion.

The assembly 600 is heated to a temperature that is above the melting temperature of the braze material 500 and below the temperature of the housing 226 and plug 602 so that the braze material 500 melts to occupy the annular gap formed between the plug 602 and the bore surface 244 via, for example, capillary action. In embodiments in which the plug 602 is configured to have a thermal expansion rate that is greater than that of the housing 226, the plug 602 expands more rapidly than the housing 226 to thereby apply pressure to the melted braze material 500 pressing it against the bore surface 244. After the braze material 500 is melted and sufficiently occupies the annular space, the assembly 600 is cooled to room temperature. It will be appreciated that the particular brazing temperature to which the assembly 600 is subjected will be dependent upon the particular materials from which the housing 226, braze material 500, and plug 602 are made, and the particular desired result.

Next, the plug 602 and a portion of the braze material 500 are removed from the bore 238, step 408. First, the plug 602 is removed using any one of numerous conventional techniques such as machining, grinding, milling, drilling, or electro-chemical machining. After the plug 602 is removed, the braze material 500 is machined until the bore 238 original diameter, contour, and surface finish are achieved.

There has now been provided a method for repairing a housing that is inexpensive and relatively simple to perform. Moreover, the method of repair allows a once-repaired housing that has been worn down again to be repaired again so that the component is salvaged and not discarded.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for repairing a housing having a bore formed therein, wherein the bore has an original diameter and a surface defined in part by the housing, the method comprising the steps of:
brazing a plug to the bore surface with a braze material, the plug having an outer diameter that is smaller than the bore original diameter; and
machining the plug and a portion of the braze material out of the bore to the bore original diameter.

2. The method of claim 1, further comprising the step of removing a portion of the bore surface to thereby increase the bore original diameter to an oversize diameter.

3. The method of claim 2, wherein the step of removing comprises grit-blasting the bore surface.

4. The method of claim 1, wherein the housing comprises a first material and the plug comprises a second material having a thermal expansion rate that is greater than the first material.

5. The method of claim 1, wherein the plug includes a heating element embedded therein.

6. The method of claim 1, wherein the housing comprises a material and the braze material is more wear-resistant than the housing material.

7. The method of claim 1, wherein the braze material is a paste and the step of brazing comprises:
spreading the paste over the bore surface; and
inserting the plug through the bore.

8. The method of claim 1, wherein the braze material is foil and the step of brazing comprises:
contacting the foil to the bore surface; and
maintaining the foil in contact with the bore surface via the plug.

9. The method of claim 1, wherein the braze material is a hollow preform and the step of brazing comprises
inserting the hollow preform through the bore; and
inserting the plug into the hollow preform.

10. The method of claim 9, wherein the step of inserting the hollow preform comprises slip-fitting the hollow preform into the bore.

11. A method for repairing a housing having a bore formed therein, wherein the bore has an original diameter and a surface defined in part by the housing, the method comprising the steps of:
removing a portion of the bore surface to thereby increase the bore original diameter to an oversize diameter;
contacting a braze material to the bore surface;
inserting a plug through the bore, the plug having an outer diameter that is smaller than the bore original diameter;
brazing the plug to the bore surface with the braze material; and
machining the plug out of the bore until the diameter of the bore formed by the braze material is returned to the bore original diameter.

12. The method of claim 11, wherein the step of removing comprises grit-blasting the bore surface.

13. The method of claim 12, wherein the housing comprises a first material and the plug comprises a second material having a thermal expansion rate that is greater than the first material.

14. The method of claim 11, wherein the plug includes a heating element embedded therein.

15. The method of claim 11, wherein the housing comprises a material and the braze material is more wear-resistant than the housing material.

16. The method of claim 11, wherein the braze material is a paste and the step of brazing comprises spreading the paste over the bore surface.

17. The method of claim 11, wherein the braze material is foil and the step of brazing comprises:
contacting the foil to the bore surface; and
maintaining the foil in contact with the bore surface via the plug.

18. The method of claim 11, wherein the braze material is a hollow preform and the step of brazing comprises
inserting the hollow preform through the bore; and
inserting the plug into the hollow preform.

19. The method of claim 18, wherein the step of inserting the hollow preform comprises slip-fitting the hollow preform into the bore.
